(19) United States
(12) Patent Application Publication
(10) Pub. No.: US 2002/0023103 A1
(43) Pub. Date: Feb. 21, 2002

(54) SYSTEM AND METHOD FOR ACCESSING AND MANIPULATING TIME-BASED DATA USING META-CLIP OBJECTS

(76) Inventor: REJEAN GAGNE, MONTREAL (CA)

Correspondence Address: PETER J. GORDON, PATENT COUNSEL, AVID TECHNOLOGY, INC., ONE PARK WEST, TEWKSBURY, MA, 01876, US

(21) Appl. No.: 09/063,289

(22) Filed: Apr. 21, 1998

(51) Int. Cl. G06F 17/24

(52) U.S. Cl. 707/501.1

(57) ABSTRACT

A system and method of accessing and manipulating time-based data allows data of at least two diverse types to be arranged with respect to a common internal time line of a meta-clip. The internal time line of the meta-clip is re-mapped, in use, to a global time line in a nonlinear editing system. The data within the meta-clip is accessed, modified and otherwise manipulated within the non-linear editing system environment as a single clip. A meta-clip in accordance with the present invention can comprise diverse data types including, without limitation, video, audio, 2D or 3D animations and their components and other meta-clips. Filters, effects or other operators can be applied to meta-clips, with some operators affecting each clip within the meta-clip and other operators affecting only clips of applicable data types within the meta clip.

### FIELD OF THE INVENTION

The present invention relates to a system and method of accessing and manipulating time-based data structures which can be of diverse types. In particular, the present invention relates to a system and method of accessing and manipulating different data types which are arranged to share a common time base.

### BACKGROUND OF THE INVENTION

It is known to store different types of time-based data in appropriate data structures, such as structures for digital video, digital audio, etc. In non-linear editing systems (NLE's), clip objects representing such data structures are accessed and manipulated relative to a time line to obtain a desired selection and arrangement of the underlying data. In a final edit, such as a television commercial produced with an NLE system, there can be clip objects for video and audio, each of which has been arranged and/or manipulated in a separate track, or set of tracks, relative to the time line of the final edit to access the information in the desired manner to obtain the final edit.

While conventional NLE clips and their underlying data structures are useful in many circumstances, they are limited to representing a single type of data, i.e.—a clip can represent digital video or digital audio, but not both. For example, the product manufactured by the assignee of the present invention and known as SoftImage|DS permits users to construct container clips wherein two or more clips of the same data type can be grouped together. While container clips are quite useful, it is not possible to group an audio sound track clip and a video clip into a container clip and this means that a user of the NLE must separately position and/or reposition related clips of different data types against the time line. Thus, if a video clip is repositioned, reused, or has its duration altered by a user, the user must locate any related other clip, such as an audio clip for related sound effects, and must reposition, reuse or alter the duration of the related clip in an appropriate manner.

It is desired to have a system and a method of accessing and manipulating diverse types of time-based data.

### SUMMARY OF THE INVENTION

It is an object of the present invention to provide a novel system and method for accessing and manipulating time-based data of at least two different types which obviates or mitigates at least one disadvantage of the prior art.

According to a first aspect of the present invention, there is provided a method of accessing and manipulating time-based data of at least two differing data types, comprising the steps of:

(i) selecting a first time-based data source storing a first data type from a selection of available data sources;

(ii) positioning a clip object representing said first time-based data source with respect to a time line to define a start time and duration for accessing said first time-based data source;

(iii) selecting a second time-based data source from said selection of available data sources, said second time-based data source being of a different data type than said first time-based data source;

(iv) positioning a clip object representing said second time-based data source with respect to said time line to define a start time and duration for accessing said second time-based data source;

(v) repeating any of steps (i) through (iv) as desired;

(vi) creating at least one meta-clip object representing said time line and each said clip object positioned relative thereto, said at least one meta-clip object being positionable with respect to a global time line of an edit such that the start time and duration of each of said first and second clip objects in said at least one meta-clip are re-mapped to said global time line; and

(vii) adding said at least one meta-clip object to said list of available data sources.

Preferably, either or both of the first and second time-based data sources can themselves comprise a meta-clip object. Also preferably, a meta-clip can include one or more operators, such as filters or effects, which can be applied within the meta-clip to the data sources therein to modify data accessed therefrom.

According to another aspect of the present invention, there is provided a method of defining in an NLE system an edit comprising time-based data of at least two different data types, comprising the steps of:

(i) selecting a first time-based data source storing a first data type from a selection of available data sources;

(ii) positioning a clip object representing said first time-based data source with respect to a time line to define a start time and duration for accessing said first time-based data source;

(iii) selecting a second time-based data source from said selection of available data sources, said second time-based data source being of a different data type than said first time-based data source;

(iv) positioning a clip object representing said second time-based data source with respect to said time line to define a start time and duration for accessing said second time-based data source;

(v) repeating any of steps (i) through (iv) as desired;

(vi) creating a new meta-clip object representing said time line and each said clip object positioned relative thereto;

(vii) adding said new meta-clip object to said list of available data sources;

(viii) repeating steps (i) through (vii) as desired;

(ix) selecting at least one meta-clip object from said list of available data sources and positioning said at least one meta-clip object with respect to a global time line of said edit;

(x) re-mapping the start time and duration of each clip object represented by said at least one meta-clip object from the time line of said at least one meta-clip object to said global time line according to the position of said at least one meta-clip object with respect to said global time line.

Preferably, either or both of the first and second time-based data sources can themselves comprise a meta-clip object. Also preferably, a meta-clip can include one or more operators, such as filters or effects, which can be applied within the meta-clip to the data sources therein to modify data therefrom. Also preferably, one or more operators can be applied to a meta-clip to modify the data from one or more data sources represented thereby.

According to yet another aspect of the present invention, there is provided a nonlinear editing system for creating an edit by accessing and manipulating time-based data of at least two different types, comprising:

a storage device to store time-based data sources of at least two different types;

a computer operatively connected to said storage device to access said time-based data sources stored therein;

at least one output device to display to a user a graphical user interface of an NLE program executed by said computer and to output the result of said edit to said user; and

at least one user input device to receive input for said NLE program from a user, said input:

(a) defining the selection of at least two clips, each clip representing a data source, at least one data source being of a different data type than another of said at least two clips;

(b) defining the positioning of each said clip object relative to a time line to define a start time and duration for each represented data source;

(c) creating and storing a meta-clip object to represent the selection and positioning of said clips relative to said time line;

(d) defining the selection of a stored meta-clip object;

(e) defining the positioning of said meta-clip object relative to a global time line of said edit; and

(f) re-mapping said start time and duration of each clip represented by said meta-clip object according to the relative positioning of said time line and said global time line.

The present invention provides a novel and useful system and method for accessing and manipulating time-based data of diverse types which are mapped to a common time-base in an NLE system. The data to be included in the edit, whether video, audio, still image or 2D or 3D animation information, is represented with clips which are arranged relative to a common internal time line of a meta-clip which is then employed within an edit in an NLE system.

The meta-clip can be positioned within an edit with respect to the global time line of the edit and event times of the clips within the meta-clip are mapped to the global time line by the NLE system. The meta-clip can be manipulated, according to known NLE actions, with respect to the global time line to change the start time, end time and duration of the meta-clip and appropriate re-mappings of the event times of the clips within the meta-clip are performed by the NLE.

Like other clips, a meta-clip in accordance with the present invention can also have effects, filters and other operators applied to it and the effect of the operator can vary appropriately for each type of time-based data represented within the meta-clip.

A meta-clip can include other meta-clips within it, allowing edits to be constructed from hierarchical sets of meta-clips and any meta-clip can be used more than once in an edit and/or in more than one edit. This allows a library of useful meta-clips to be created, stored and presented to users to employ in their edits.

Additional advantages and features of the invention will be apparent from the following discussion of the invention.

### BRIEF DESCRIPTION OF THE DRAWINGS

Preferred embodiments of the present invention will now be described, by way of example only, with reference to the attached Figures, wherein:

FIG. 1 shows a representation of an NLE system in accordance with the present invention;

FIG. 2 shows a schematic representation of an edit produced in an NLE system;

FIG. 3 shows another edit in the NLE system of FIG. 2;

FIG. 4 shows the edit of FIG. 2 after it has been modified;

FIG. 5 shows a representation of a meta-clip in accordance with the present invention;

FIG. 6 shows an edit employing the meta-clip of FIG. 5 in accordance with the present invention;

FIG. 7 shows the edit of FIG. 6 wherein the meta-clip of FIG. 5 has been repositioned and the duration of another clip has been reduced;

FIG. 8 shows a representation of another meta-clip in accordance with the present invention;

FIG. 9 shows a representation of the output produced with a meta-clip in accordance with the present invention;

FIG. 10 shows the meta-clip which represents the data producing the output of FIG. 9; and

FIG. 11 shows an edit including the meta-clip of FIG. 10.

### DETAILED DESCRIPTION OF THE INVENTION

In conventional NLE systems, each data source, or portion of a data source, is represented as a clip object which corresponds to the relevant data which is available to the user. A clip can represent a portion of data for a still image, video or audio. In an NLE system developed by the assignee of the present invention, and described in co-pending U.S. patent application •, a clip object can also represent rendered 2D or 3D animations and/or the components employed in creating the animation including, but not limited to: a model definition and/or one or more animated parameters applied to the model; images; camera or lighting definitions; etc. In all cases, clip objects are manipulated relative to a global time line and all clip objects employed in the edit have at least a start time, an end time and a duration. As used herein, the term “time-based data” is intended to comprise all of these diverse data types which can be positioned with respect to a time line in an NLE system.

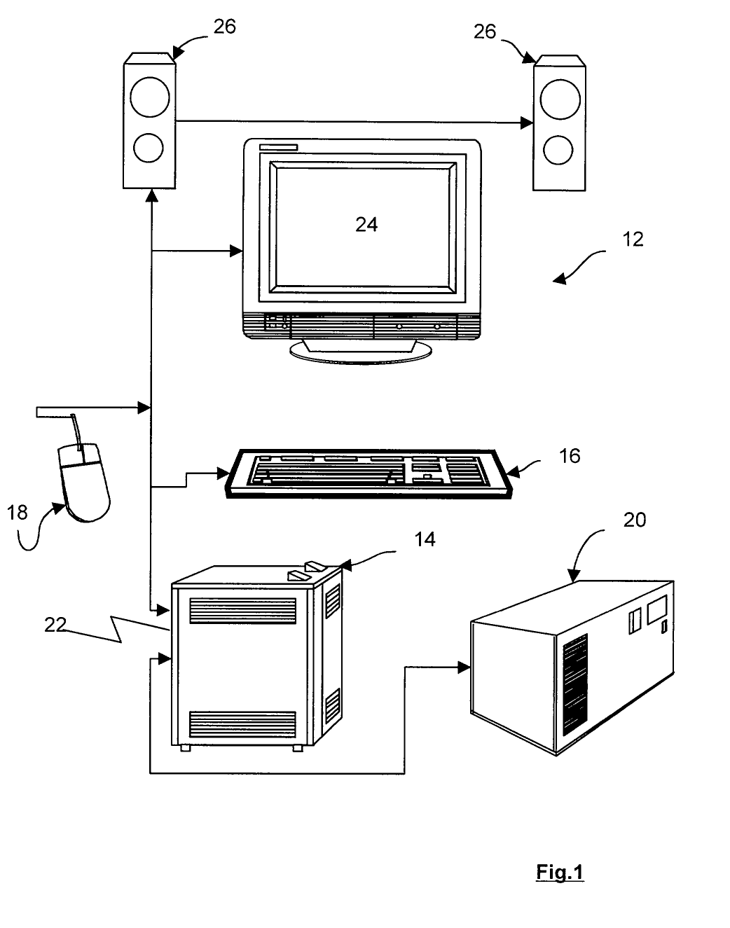

FIG. 1 shows an example of an NLE system 12 in accordance with an embodiment of the present invention. System 12 includes a computer which, for example, can be a general purpose computer system 14 such as a PC with an Intel Pentium® processor and executing Microsoft Windows NT® or a special purpose computer system executing a program to implement an NLE. Computer system 14 is connected to one or more user input devices, such as keyboard 16, mouse 18, or any other suitable user input device such as a graphics tablet (not shown), etc. While computer system 14 will generally include a nonvolatile storage device, additional data storage can be provided by a storage device such as RAID array 20, optical disc drives (not shown), digital video tape recorders (not shown), etc.

As will be apparent to those of skill in the art, computer system 14 can be directly connected to storage devices, such as RAID array 20, and/or be connected to storage devices via a suitable communications links, such as LAN network connection 22, via the internet, etc. System 12 also includes one or more output devices, such as high resolution monitor 24 and speaker system 26. In the embodiment of FIG. 1, the graphical user interface (GUI), described further below, of the NLE system and the visual outputs of the edit being produced are each displayed, either simultaneously or alternately, on monitor 24. It is also contemplated however, that in some circumstances more than one monitor 24 may be provided to allow output to be displayed on one or more monitors while the GUI of the NLE is displayed on another.

In general, data to be manipulated with system 12 is produced and stored on a storage device before or during use of system 12. Such data is accessed by computer system 14, as required, in response to input received from a user via the user input devices. The user can observe and/or hear the results of the edit constructed from and/or any changes to this data on the output devices and the edit and/or changes to the data can be stored on the storage devices.

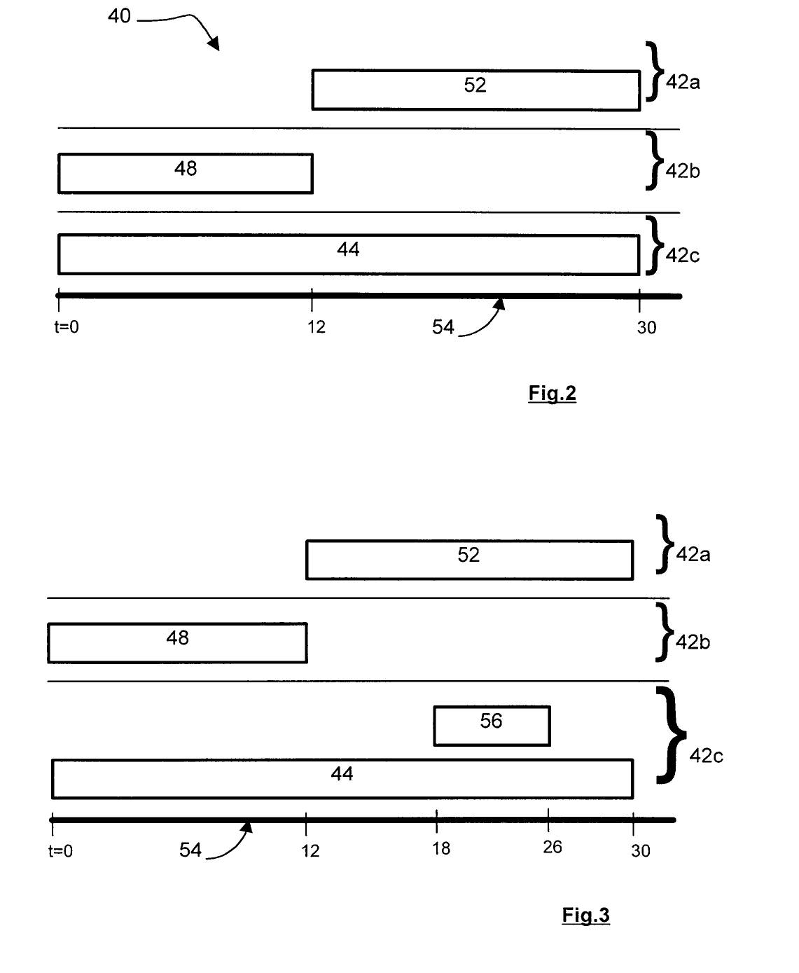

FIG. 2 shows a schematic example of a graphical user interface 40 of an NLE system. In this example, the output, or edit, produced by the NLE is a thirty second television commercial which comprises three clips 44, 48 and 52, each of which represents a different type of data which is placed in a different one of tracks 42a, 42b and 42c. In this example, clip 44 represents a digital audio source which has a start time of t=0 seconds and an end time of t=30 seconds, for a duration of thirty seconds relative to the global time line 54 of the edit. Clip 48 represents a digital (or digitized) video source with a start time of t=0 seconds and an end time of t=12 seconds, for a duration of twelve seconds relative to global time line 54. Clip 52 represents a rendered 3D animation source which has a start time of t=12 seconds and an end time of t=30 seconds, for a duration of eighteen seconds relative to global time line 54. As will be apparent, the output from this edit comprises a thirty second portion of the audio soundtrack represented by clip 44 which plays while, for the first twelve seconds, a twelve second portion of the video segment represented by clip 48 is shown followed by an eighteen second portion of the rendered 3D animation represented by clip 52.

Clips of different data types are placed in separate tracks in an NLE system such as that shown in FIG. 2. For example a clip representing audio data such as clip 44 is placed in a different track than a clip representing video data, such as clip 48. Clips representing data of the same type can also be placed in separate tracks, if desired, to allow an edit to be organized to allow location of portions of an edit by a user. For example, two or more clips representing video information for different parts of an edit (i.e. opening titles and a scene in the edit) can be placed in separate tracks by the user so that these different parts of the edit can be readily located. Also, as discussed below, clips to which transitions such as wipes, dissolves are to be applied are placed in separate adjacent tracks.

Various effects can be applied to various clips, or portions of clips, such as a Reverb effect applied to clip 44 or a Jitter effect applied to video clip 48, each of which alters the presentation of the underlying source data. The edit can be changed by the user in a variety of manners. For example, clips 44, 48 and 52 can be repositioned relative to global time line 54 to change the start time and end time of the clips. Additional clips can be added and/or one or more of clips 44, 48 and 52 can be removed. Clips 44, 48 and/or 52 can be resized to alter the start time or the end time to alter the duration of the clip and/or to select a different portion of the source to be employed in the edit. Filters and effects can be added to or removed from clips as desired. As will be apparent to those of skill in the art, such manipulations of clips such as clips 44, 48 and 52 can be accomplished in a variety of known manners within GUI 40. For example, well known pointing, clicking and dragging operations can be performed on the clips with mouse 18.

While NLE systems, such as that shown in FIG. 2, have proven themselves to be quite useful, they do suffer from disadvantages. For example, FIG. 3 shows an edit similar to the edit shown in FIG. 2, but wherein an additional clip 56, which represents audio sound effects related to the rendered 3D animation of clip 52, has been added to track 42c. In this example, clip 48 represents a 3D animation of a first character and clip 52 represents another 3D animation of a different character who walks and bumps into a garbage can or other object and clip 56 represents the sound effects of the garbage can being hit. As shown in the Figure, clip 56 has a start time of t=18 seconds relative to global time line 54 as the character in clip 52 hits the garbage can six seconds after the start time (t=12) of clip 52, i.e.—at t=18. Clip 44, which represents the sound of the character walking, and clip 56 are mixed together, between t=18 and t=26, to produce the desired audio soundtrack and the sound effects of clip 56 are synchronized with the collision between the character and the garbage can.

However, a difficulty arises with such edits when a first clip is manipulated which has other clips associated with the first clip which are time dependent upon it. For example, as shown in FIG. 4, while moving clip 52 to a start time of t=10, and moving the end time of clip 48 accordingly is easily accomplished, but clip 56 remains where it was originally positioned, thus “breaking” the soundtrack. Specifically, the collision between the animated character and the garbage can in clip 52 now occurs at t=16 but the collision sound in clip 56 is no longer synchronized as it still occurs at t=18. While in this trivial example it is quite easy to appropriately reposition clip 56 to again synchronize it with the collision in clip 52, in reality edits generally include many clips and it can be onerous, time consuming and even impractical to reposition multiple associated clips every time a change is made to one or more clips during the editing process.

The present inventors have developed a system and method for accessing and manipulating time-based data which allows clips representing diverse time-based data types to be grouped into a structure, referred to herein as a meta-clip, which maintains the relative time relationship between the grouped data.

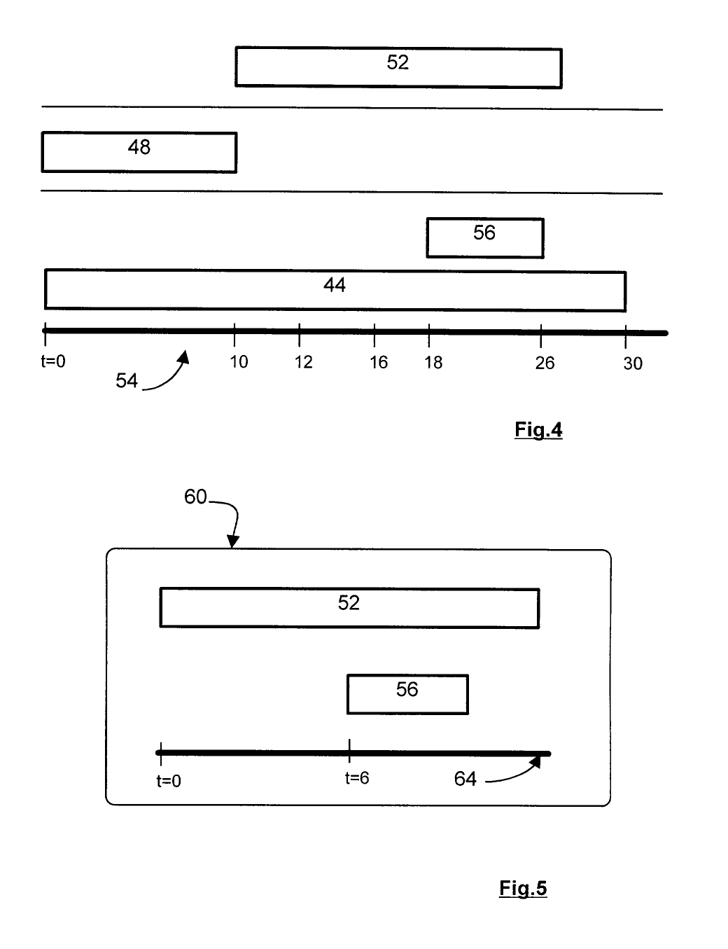

Using the present invention, clip 52 and clip 56 of FIG. 3 can be grouped into a meta-clip 60, as shown in FIG. 5. Each meta-clip 60 includes an internal time line 64 against which clips 52 and 56 are positioned to define their timing, relative to one another. As shown, clip 52 has a start time of t=0, relative to time line 64, and clip 56 has a start time of t=6, relative to time line 64, the collision between the character and garbage can of clip 52 occurring six seconds after the start of clip 52. Construction of a meta-clip 60 can be performed in a variety of manners. For example, a command to construct a meta-clip can be selected in GUI 40 from a menu (not shown) and a meta-clip definition window can be presented to the user in the NLE. This meta-clip definition window will be empty, apart from the internal time line 64. The user can then select desired clips for the meta-clip from a list of available clips (not shown) in GUI 40. These clips can be sized, positioned and arranged relative to the internal time line 64. The output of meta-clip 60 can be provided to the user, in the same manner as the output of an edit can be provided to the user, to allow the meta-clip to be refined in an iterative manner.

Once the user is satisfied with the construction of a meta-clip 60, a command to collapse the contents of the meta-clip can be selected from a menu in the GUI and the meta-clip definition windows is closed and the meta-clip is added to the list of available clips from which the user can select for the edit. It is also contemplated that any edit can be collapsed to a meta-clip 60 by selecting a collapse edit to meta-clip command from a menu in the GUI. Essentially, this command converts the edit to a meta-clip by changing the global time line 54 of the edit to an internal time line 64 of a meta-clip 60 and collapses the resulting meta-clip to the list of available clips and replaces the edit window in the GUI with a new, blank edit window.

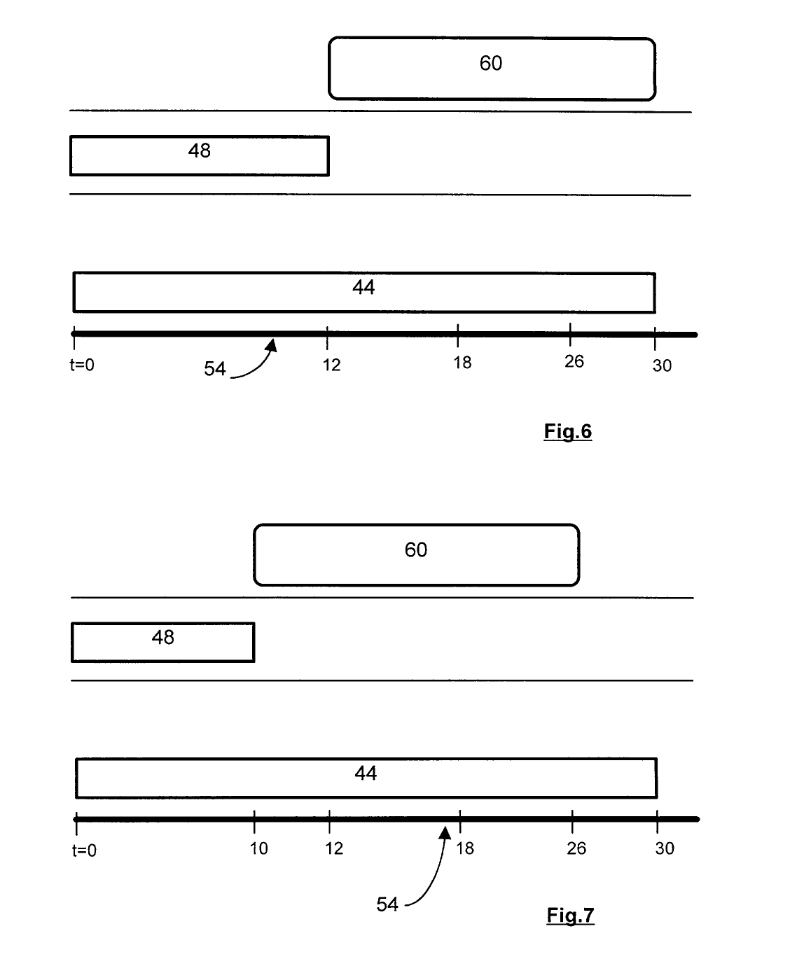

FIG. 6 shows meta-clip 60 positioned at time t=12 relative to global time line 54 and the contents of meta-clip 60 are employed in the edit with t=0 on time line 64 being effectively re-mapped within the edit to t=12 on global time line 54. When a meta-clip 60 is positioned within an edit, the NLE system determines the mapping of the time of each event, such as the start or end of a clip, in the meta-clip from the internal time line 64 of the meta-clip to the global time line 54 of the edit. Essentially, this is determined by determining the offset between t=0 of the internal time line 54 and the start time, relative to global time line 54, at which the meta-clip has been positioned.

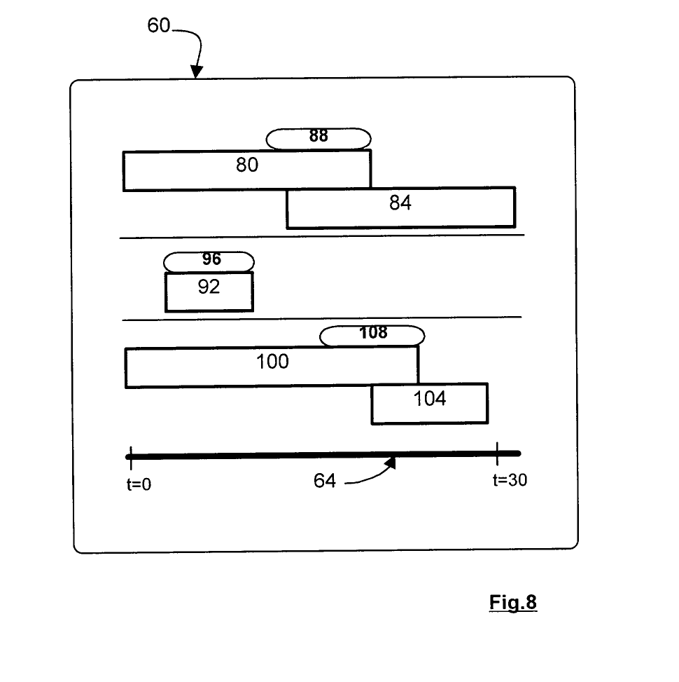

As a result of the re-mapping, clip 52 has a start time of t=12, relative to global time line 54 and the start time of clip 56 is effectively re-mapped within the edit to time t=18, relative to global time line 54. When the edit is modified by re-positioning meta-clip 60, for example to t=10 as shown in FIG. 7, the mappings between clips 52 and 56 and global time line 54 are effectively updated by the NLE system so that clip 52 now has a start time of t=10, relative to global time line 54, and clip 56 has a start time of t=16, relative to global time line 54.

Meta-clips 60, in accordance with the present invention, are not limited to providing for the grouping of video and audio data, and can in fact be employed with any time-based data and/or any time-based effect, filter or other modifier which is applied to a clip or to a track.

For example, FIG. 8 shows another meta-clip 60 which includes two video clips, 80 and 84, which have a wipe transition 88 applied to them. As is known to those of skill in the art, a wipe transition is a transition from one video or image to another which is effected by a transition line which “wipes” across the display, replacing the first source with the second source on the portion of the display where the transition line has traveled.

In FIG. 8 an audio clip 92, which can represent a collision noise or other sound effect, is also included and has an effect 96, such as a reverb effect, applied to it. Finally, two additional audio clips 100 and 104 are included and have a mixer effect 108 applied to them. Clips 100 and 104 can, for example, represent two song portions. As will be apparent to those of skill in the art, meta-clip 60 in this example is manipulated within an NLE in a manner identical to that described above with reference to FIGS. 6 and 7.

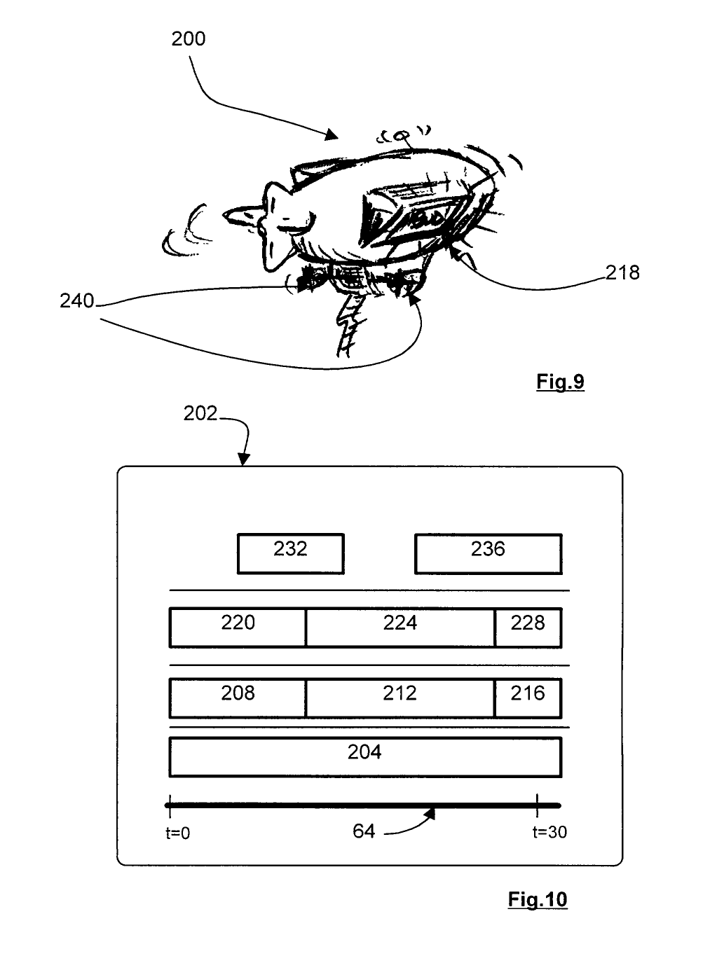

Another aspect of the present invention is its ability to incorporate data sources which comprise 2D or 3D animation information, such as animation models and time versus position curves, motion capture data and other information and actions, etc. For example, FIG. 9 shows an animated blimp 200 which can be employed as a component in a beer commercial wherein blimp 200 is composited onto a video clip of a football stadium.

FIG. 10 shows a meta-clip 202 for blimp 200. As shown, in this example meta-clip 202 comprises an animation clip 204 which represents the animated blimp, three video clips 208, 212 and 216 which each represent video information which is displayed on the television 218 located on the side of the blimp. Each of video clips 208, 212 and 216 has a corresponding audio clip 220, 224 and 228 which are intended to be synchronized with the videos. In addition to the audio clips for the videos, two audio clips 232 and 236 are included and represent suitable engine noises to be used when the engines 240 on blimp 200 are operating.

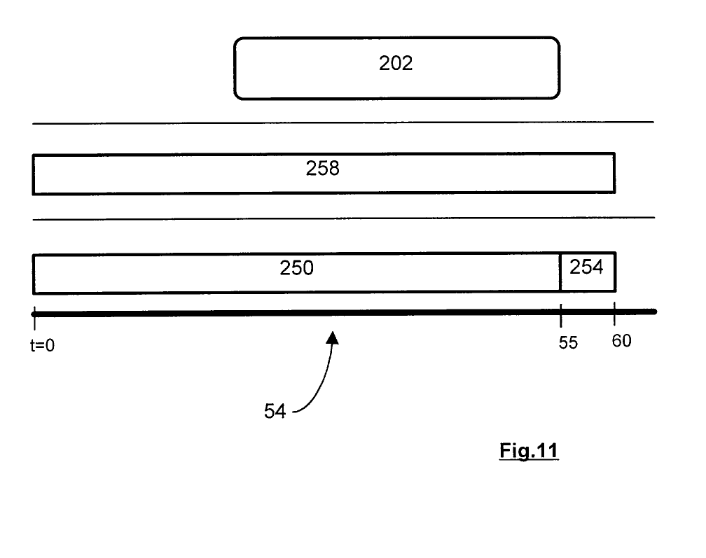

FIG. 11 shows an NLE edit to produce a beer commercial with meta-clip 202 of blimp 200. As shown, the edit can include a clip 250 of video of a football stadium crowd, followed by a clip 254 of an image of advertising text, a clip 258 of audio of crowd sounds and cheering and meta clip 202. As will be apparent, the NLE user can modify the time at which blimp 200 appears in the finished edit by merely repositioning meta-clip 202 with respect to global time line 54 and each component clip of meta-clip 202 will be repositioned/re-mapped correspondingly.

Further, the duration of meta-clip 202 can be altered, by moving the right hand side of meta-clip 202 toward the left hand side, for example, or by any other suitable operation supported by the NLE. For example, meta-clip 202 can have five seconds cropped from its end to obtain a duration of twenty-five seconds, rather than the original thirty second duration. In such a case, each clip within meta-clip 202 which was active (i.e.—forming part of the output of meta-clip 202) in the last five seconds of the total duration of meta-clip 202 (i.e.—relative to time line 64) will be changed to an inactive status twenty five seconds after the start of internal time line 64.

Similarly, if a meta-clip, such as meta-clip 202, has less than its total duration employed within an edit, the meta-clip duration can be extended by any suitable action supported by the NLE. In such a case, any clips within the meta-clip which would be active in the extended portion of the duration are set to an active status in that duration.

Also, meta-clip 202 can be employed more than once in an edit and/or can be included in more than one edit. For example, in the above-described beer commercial it may be desired that the blimp cross the image of the stadium (clip 250) and subsequently cross the advertising text (clip 254) as well.

The present invention also provides that a clip in a meta-clip can itself be a meta-clip, arranged in a hierarchy, allowing final edits to be defined in a layered manner. For example, animation clip 202 in FIG. 10 can itself be a meta-clip including a clip representing the 3D geometry of the blimp object, a clip representing the time versus position curve that the blimp object follows, a pair of clips each representing one of the propellers on the blimp's engines and a corresponding pair of clips defining the time versus position curves for those propellers. As will be apparent, in this case the internal time lines 64 of each meta-clip 60 in the hierarchy is mapped to the internal time line 64 of the meta-clip 60 immediately above it in the hierarchy until the topmost meta-clip 60 in the hierarchy has its internal time line 64 mapped to the global timeline 54 of the edit. Construction of the hierarchy is performed by creating a meta-clip as described above and selecting one or more meta-clips 60 and other clips which have been previously created from the above-mentioned list of available clips. This process can be repeated as desired to create a meta-clip hierarchy of essentially any depth.

Effects, filters and/or other operators can also be applied to meta-clips in an NLE edit, much like any other clip therein. Some operators applied to a meta-clip can act on all the clips within the meta-clip, irrespective of the data type, and other operators will only be applied to clips of the appropriate data types within the meta-clip. For example, a “FadeOut” operator can be applied to the last half of meta-clip 202 in FIG. 21 with the result that the volume of the active audio clips fades and the active video clips fade to black. Conversely, a “Reverb” operator applied to meta-clip 202 would result in a reverberation filter being applied to the active audio clips in meta-clip 202, but would have no effect on the active video clips.

The present invention provides a novel and useful system and method for accessing and manipulating time-based data of diverse types which are mapped to a common time-base. The data is represented with clips which are arranged relative to a common time line of a meta-clip which is then employed within an edit in an NLE system. The meta-clip can be manipulated according to known NLE actions to change its start time, end time and/or duration and effects, filters and other operators can be applied to the meta-clip to modify its contents. A meta-clip can include other meta-clips within it, allowing an edit to be constructed from a hierarchical set of meta-clips and a meta-clip can be used more than once in an edit and/or in more than one edit.

The present invention is not intended to be limited to the specific embodiments described above and it is contemplated that modifications and alterations will occur to those of skill in the art and can be effected thereto without departing from the scope of the invention, as defined by the claims attached below.

I claim:

1. A method of accessing and manipulating time-based data of at least two differing data types, comprising the steps of:
(i) selecting a first time-based data source storing a first data type from a selection of available data sources;
(ii) positioning a clip object representing said first time-based data source with respect to a time line to define a start time and duration for accessing said first time-based data source;
(iii) selecting a second time-based data source from said selection of available data sources, said second time-based data source being of a different data type than said first time-based data source;
(iv) positioning a clip object representing said second time-based data source with respect to said time line to define a start time and duration for accessing said second time-based data source;
(v) repeating any of steps (i) through (iv) as desired;
(vi) creating at least one meta-clip object representing said time line and each said clip object positioned relative thereto, said at least one meta-clip object being positionable with respect to a global time line of an edit such that the start time and duration of each of said first and second clip objects in said at least one meta-clip are re-mapped to said global time line; and
(vii) adding said at least one meta-clip object to said list of available data sources.

2. The method as defined in claim 1 wherein at least one of said first and second available data sources comprises a first meta-clip object, each time-based data source in said first meta-clip object being mapped to said time line of said at least one meta-clip object and, in turn, to said global time line.

3. The method as defined in claim 1 further comprising the steps of selecting and applying at least one operator to one or more of said first and second time-based data sources to modify data therefrom, said at least one operator being positioned relative to said time line and said operators comprising at least one of a filter and an effect.

4. A method of defining in an NLE system an edit comprising time-based data of at least two different data types, comprising the steps of:
(i) selecting a first time-based data source storing a first data type from a selection of available data sources;
(ii) positioning a clip object representing said first time-based data source with respect to a time line to define a start time and duration for accessing said first time-based data source;
(iii) selecting a second time-based data source from said selection of available data sources, said second time-based data source being of a different data type than said first timebased data source;
(iv) positioning a clip object representing said second time-based data source with respect to said time line to define a start time and duration for accessing said second time-based data source;
(v) repeating any of steps (i) through (iv) as desired;
(vi) creating a new meta-clip object representing said time line and each said clip object positioned relative thereto;
(vii) adding said new meta-clip object to said list of available data sources;
(viii) repeating steps (i) through (vii) as desired;
(ix) selecting at least one meta-clip object from said list of available data sources and positioning said at least one meta-clip object with respect to a global time line of said edit;
(x) re-mapping the start time and duration of each clip object represented by said at least one meta-clip object from the time line of said at least one meta-clip object to said global time line according to the position of said at least one meta-clip object with respect to said global time line.

5. The method as defined in claim 4 wherein at least one of said first and second available data sources comprises a first meta-clip object, each time-based data source in said first meta-clip object being re-mapped to said time line of said at least one meta-clip object and, in turn, to said global time line.

6. The method as defined in claim 4 further comprising the steps of selecting and applying at least one operator to one or more of said first and second time-based data sources to modify data therefrom, said at least one operator being positioned relative to said time line and said operators comprising at least one of a filter and an effect.

7. The method as defined in claim 4 further comprising the steps of selecting and applying at least one operator to said at least one meta-clip object to modify data from at least one of the time-based data sources thereby represented, said at least one operator being positioned relative to said global time line and said operators comprising at least one of a filter and an effect.

8. The method of claim 7 wherein said at least one operator functions to modify data from each time-based data source represented by said meta-clip.

9. The method of claim 4 further comprising the steps of, when the duration of said at least one meta-clip object is shortened:
(a) examining each clip object represented by said meta-clip object to determine if any portion of the data source represented by said clip object is outside of said altered duration; and
(b) marking any such determined portion inactive to prevent data from said data source within said portion from being included in said edit.

10. The method of claim 4 further comprising the steps of, when the duration of said at least one meta-clip object is lengthened:
(a) examining each clip object represented by said meta-clip object to determine if any portion of the data source represented by said clip object which was previously outside of said altered duration is now inside; and
(b) marking any such determined portion active to allow data from said data source within said portion to be included in said edit.

11. A nonlinear editing system for creating an edit by accessing and manipulating timebased data of at least two different types, comprising:
a storage device to store time-based data sources of at least two different types;
a computer operatively connected to said storage device to access said time-based data sources stored therein;
at least one output device to display to a user a graphical user interface of an NLE program executed by said computer and to output the result of said edit to said user; and
at least one user input device to receive input for said NLE program from a user, said input:
(a) defining the selection of at least two clips, each clip representing a data source, at least one data source being of a different data type than another of said at least two clips;
(b) defining the positioning of each said clip object relative to a time line to define a start time and duration for each represented data source;
(c) creating and storing a meta-clip object to represent the selection and positioning of said clips relative to said time line;
(d) defining the selection of a stored meta-clip object;
(e) defining the positioning of said meta-clip object relative to a global time line of said edit; and
(f) re-mapping said start time and duration of each clip represented by said meta-clip object according to the relative positioning of said time line and said global time line.
